(19) United States
(12) Patent Application Publication
(10) Pub. No.: US 2008/0094408 A1
(43) Pub. Date: Apr. 24, 2008

(54) System and Method for Geometry Graphics Processing

(76) Inventors: Xiaoqin Yin, Hsinchu City (TW); Jinshan Zheng, Hsinchu City (TW); Fang Xia, Hsinchu City (TW); Pingping Shao, Hsinchu City (TW); Jianbo Zhang, Hsinchu City (TW); Lixia Yan, Hsinchu City (TW)

Correspondence Address: JOHN CHEN, ROOM 303, 3F, NO. 25, SEC. 1, CHANGAN E. ROAD, TAIPEI, 10441, omitted

(21) Appl. No.: 11/552,150

(22) Filed: Oct. 24, 2006

(51) Int. Cl. G09G 5/00

(52) U.S. Cl. 345/581

(57) ABSTRACT

The present invention provides a method and system for graphics processing. The graphics processing system comprises the primitive assembly, a vertex/geometry shader, the second primitive assembly, a cache memory, and a texture engine. The vertex/geometry shader can receive primitive data to execute can output vertex data.

### BACKGROUND OF THE PRESENT INVENTION

1. Field of Invention

The present invention relates to a graphics processing system and more particularly, to a graphics processing system with a combined shader.

2. Description of Related Arts

A shader is a program used in 3D computer graphics to determine the final properties of an object or image. This often includes arbitrarily complex descriptions of light absorption and diffusion, texture mapping, reflection and refraction, shadowing, surface displacement and post-processing effect. A vertex shader deals with the relevant calculations of the vertex. A fragment shader deals with the relevant calculations of the pixel.

Generally the graphics scene is constituted by lots of primitives, including points, lines, triangles, etc. Furthermore, a primitive is constituted by one ore more vertices. For more flexibility, some user programmable units are added into the graphics system to take place of the fixed function units. FIG. 1 illustrates the System (100), a typical graphics pipeline currently available.

The graphics pipeline in FIG. 1 can be divided into two coarse stages: geometry processing stage (101) and fragment processing stage (102). In the geometry processing stage, the Vertex Fetch/Put (103) prepares the vertex data. The Vertex Shader (104) executes user specified micro program on per vertex data. It takes place of traditional fixed function T&L stage. The Primitive Assembly (105) gets vertices from Vertex Shader (104) and assembly them into primitives. As a simple example, 3 vertices can be assembled into a triangle. The assembled primitives then are passed to Clip/Cull/Viewport Unit (106). The processing in unit (106) can only be done on primitive base. The clipping and culling are used to drop invisible primitives to decrease the workload of fragment processing stage (102).

The Rasterization Engine (107) renders primitives into 2D pixels. And the Fragment Shader (108) executes user specified micro programs on every pixel produced by Rasterization Engine (107). The result of Fragment Shader (108) will finally be written into Frame Buffer (109). Both Vertex Shader (104) and Fragment Shader (108) can do texture look up according to OpenGL 2.0 and DirectX 9.0c. So a Texture Engine (110) is accessible to both of them.

As showed in FIG. 1, the vertex processing can be user-defined by specifying vertex shader program. The fragment processing can also be user-defined by specifying fragment shader program. But all primitive based processing is fixed function instead of a user-defined function. It is the trend to add user programmable primitive shader into the graphics pipeline. For example, in Microsoft's next generation graphics API WGF 2.0, a “Geometry Shader” is added into the geometry processing stage. The “Geometry Shader” can execute user-defined micro program on each input primitive. Unlike Vertex Shader, which operate on a single vertex, the Geometry Shader will handle a whole primitive per invocation (one vertex for points, two vertices for lines, three vertices for triangles, etc.). Optional adjacent vertices can also be input to Geometry Shader (two adjacent vertices for lines, three adjacent vertices for triangle, no adjacent vertex for point).

FIG. 2 illustrates another geometry processing architecture with a user programmable “Geometry Shader”. Some of its components of the system 200 are the same as the System 100: Vertex Fetch/Put (103), Vertex shader (104), Texture Engine (110), Clip/Cull/Viewport (106) and the whole Fragment Processing stage (102). The newly added unit is Geometry Shader (203). Because Geometry Shader (203) inputs primitives and outputs multiple primitives in vertex format, so two primitive assembly units are needed. The first Primitive Assembly (202) is placed between Vertex Shader (104) and Geometry Shader (203). This Primitive Assembly will get vertices from Vertex Shader, and assemble them into primitives for Geometry Shader. The second Primitive Assembly (204) is placed between Geometry Shader (203) and the later unit (106) in the geometry processing stage. The Geometry Shader (203) emits vertices to the second Primitive Assembly, and it assembles them into primitives for later geometry processing units.

### SUMMARY OF THE PRESENT INVENTION

The object of the present invention is to decrease the chip area of a graphics processing system.

The other object of the present invention is to provide flexibility to accommodate various graphics pipeline configurations.

The other object of the present invention is to automatically balance the workload between vertex shader and geometry shader for different real cases.

Accordingly, in order to accomplish the one or some or all above objects, the system comprises the first primitive assembly to provide primitive data for the vertex/geometry (VG) shader, and the VG shader capable of executing the vertex shader on the primitive data and then executing the geometry shader to output vertex data, and the second primitive assembly to provide the primitive data for the output of the VG shader.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic block diagram of a typical graphics pipeline.

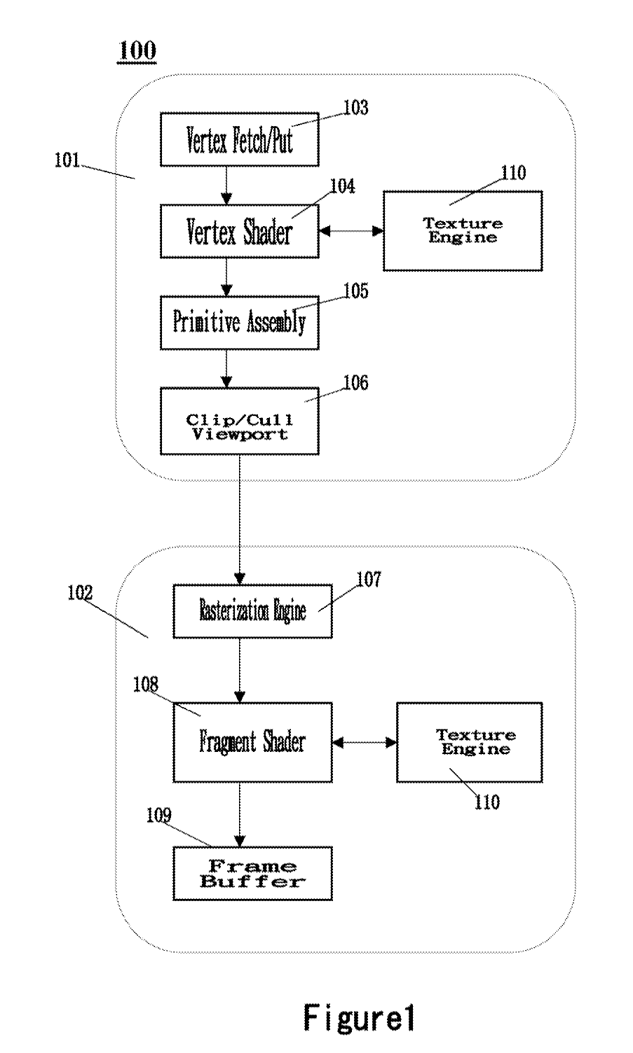

FIG. 2 is the other schematic block diagram of a typical graphics pipeline with a geometry shader.

FIG. 3 is a block diagram of the combined vertex/geometry shader architecture of the present invention.

FIG. 4 is an embodiment of the VG shader architecture in hardware.

FIG. 5 is the flow chart of the VG shader program.

### DETAILED DESCRIPTION OF THE PREFERRED EMBODIMENT

The differences between Vertex Shader and Geometry Shader can be listed as following: (1) Input data are different. Vertex Shader is executed on each input vertex, Geometry is executed on each input primitive. That's to say, Vertex Shader inputs one vertex by each invocation; Geometry Shader inputs multiple vertices (one vertex for point, . . . , at most 6 for triangle with adjacent) by each invocation. (2) Output data are different. For each input vertex, there is exactly one output vertex from Vertex Shader. For each input primitive, there may be multiple output primitives from Geometry Shader, and the output primitive type may be changed. (3) The purposes are different. Vertex Shader operates on vertex base, it was originally added to replace Transform and Light (TnL). Geometry Shader is added to provide flexibility on primitive based processing. The tasks which need primitive information can only be accomplished in Geometry Shader.

In spite of the differences just mentioned, Vertex Shader and Geometry Shader are common in some other aspects. (1) They use the same instruction set, with only few exceptions. ALU instructions, flow control instructions, texture access instructions are the same. (2) Both of them will operate on vertex data finally. Actually, a primitive is composed of one or more vertices. (3) The coarse structures of vertex shader and geometry shader are similar. For example, the definitions of Constant/Temp are similar.

The present invention is primarily about a graphics processing method and a system to form a shader unit for both Vertex Shader and Geometry Shader. The Vertex Shader and Geometry Shader are combined to be a single shader unit, with the name “Vertex/Geometry Shader”, or “VG Shader” for short.

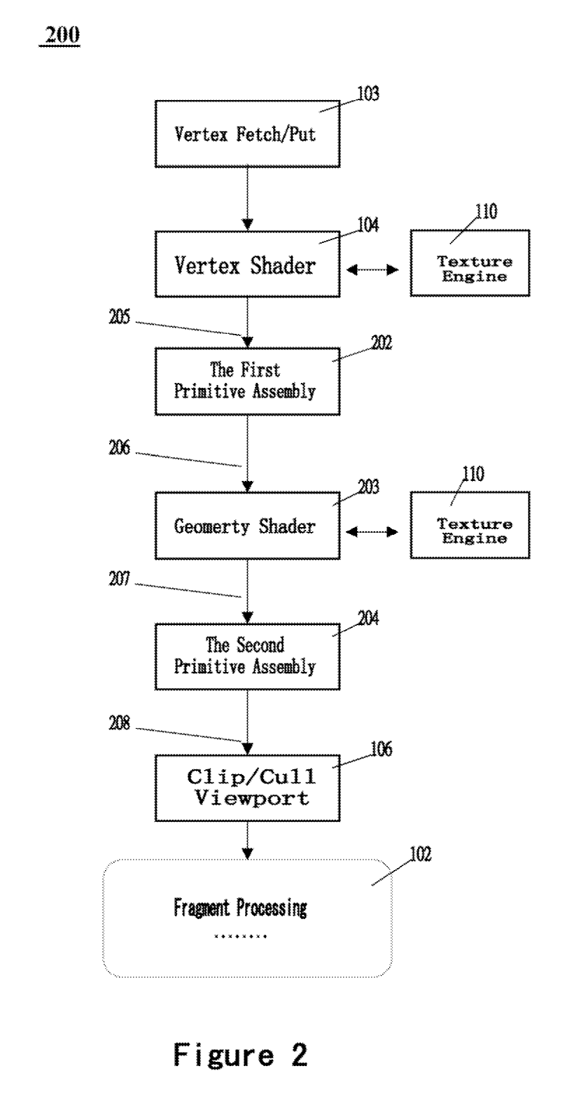

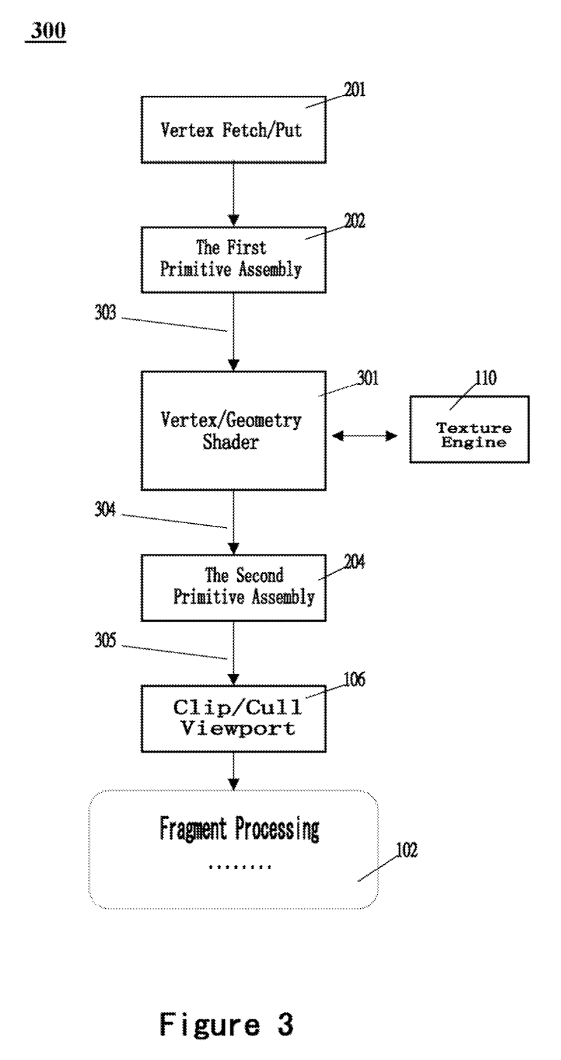

The FIG. 3 is an embodiment of a schematic block diagram of the present invention. Compared with FIG. 2, many components are kept unchanged. The system 300 includes Vertex Fetch/Put (201), The first primitive assembly (202), G/S Shader (301),

Texture Engine (110), the second primitive assembly (204), and the Clip/Cull/Viewport (106). But the first Primitive Assembly (202) is moved forward. It gets vertex data from Vertex Fetch/Put (201) directly, and assembles them into primitives and pass to VG Shader (301). Conceptually, a user specified program in VG Shader can be split into two phases: vertex processing phase and geometry processing phase. In vertex processing phase, VG Shader finishes executing vertex shader program on all vertices in the current primitive. And then in geometry processing phase, the geometry shader program is executed on the current primitive. Since the two shaders are combined into one single VG Shader (301), there is only one Texture Engine (110) connected to provide texture access both for vertex processing phase and geometry processing phase. Multiple vertices are emitted from VG Shader (301), and the second Primitive Assembly (204) receives them and assembles them into primitives for later fixed function geometry processing stages.

The present invention changes the fashion of doing vertex shader from vertex base to primitive base. So the vertex shader can be combined with geometry shader into a single shader unit, which operates on primitive base. In the general cases, some vertices are used by more than one primitive. In the traditional way, the vertex shader program is executed only once for each vertex. All vertex data input to the first Primitive Assembly (202) have had their vertex shader processing done. But the present invention combines the Vertex Shader and Geometry Shader into a single VG Shader, and the first Primitive Assembly (202) gets vertex data from Vertex Fetch/Put (103) directly. It is the VG Shader (301) who executes the vertex shader program on input vertices. For example, four vertices are passed from Vertex Fetch/Put (103) to the first Primitive Assembly (202), indicated by v0, v1, v2, v3. The first Primitive Assembly (202) assembles them into two triangles, t0(v0, v1, v2) and t1(v1,v2,v3). Two vertices, v1 and v2, are used twice for both t0 and t1. Then t0 and t1 will be passed to VG Shader (301). When processing t0, the VG Shader (301) firstly execute vertex shader program on vertices v0, v1, and v2. When processing t1, the VG Shader (301) firstly executes vertex shader program on vertices v1, v2, and v3. Definitely the vertex shader processing on v1 and v2 is redundant and wasteful. The present invention also provides some mechanism to make sure the vertex shader processing is only done once for each vertex.

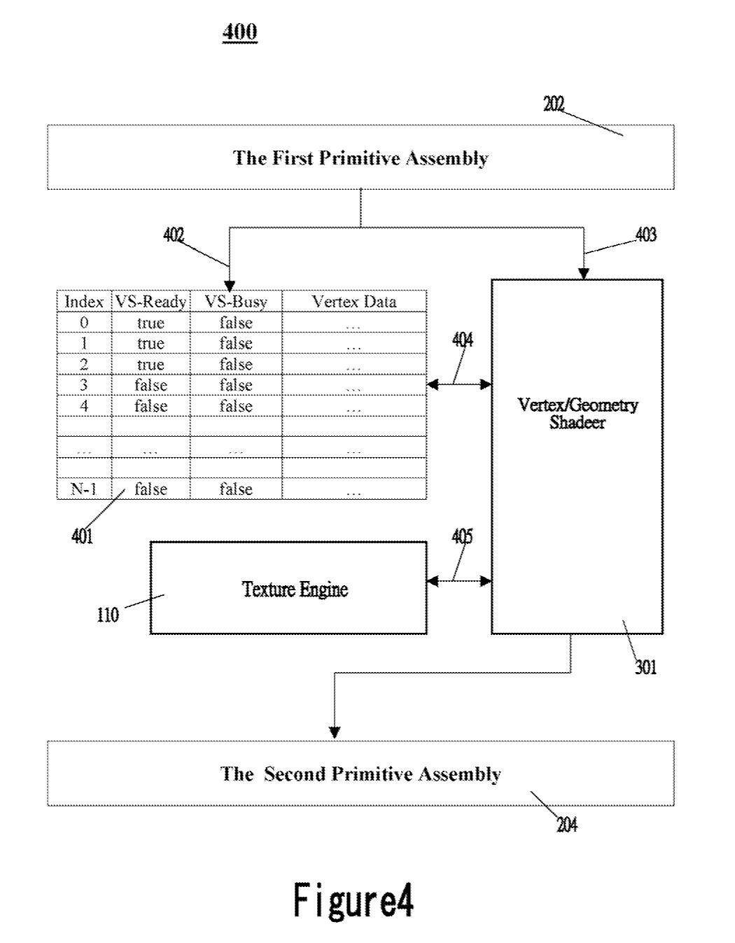

FIG. 4 illustrates an embodiment of the present invention. Compared with System 300 illustrated in FIG. 3, the Vertex Cache (401) is displayed. The other engines are almost the same, such as VG Shader (301). The first Primitive Assembly (202), the second Primitive Assembly (204) and Texture Engine (101). The first Primitive Assembly (202) and the second Primitive Assembly (204) may be the circuits to convert the vertex data into the primitive data. The circuits may be the registers with the function for converting data. The VG shader (301) may be a processor. The first Primitive Assembly (202) writes vertex data to Vertex Cache (401) for the missed vertices. The primitives sent to VG Shader (301) from The first Primitive Assembly (202) are described by the IDs of vertices. For example, if the first Primitive Assembly (202) wants to send primitive t0(v0, v1, v2) to VG Shader (301), it sends missed vertex data of v0/v1/v2 to Vertex Cache (401) and sends the vertex IDs of (0, 1, 2) to VG Shader (301) to indicate the primitive t0.

The Vertex Cache (401) can be both read and written by VG Shader (301), the interface (404) between Vertex Cache (401) and VG Shader (301) is bi-directional. After The first Primitive Assembly (202) writes unprocessed vertex data into Vertex Cache (401), the Vertex Cache (401) acts as three roles: vertex shader (VS) input, VS output and geometry shader (GS) input. That's to say, the vertex shader phase of VG Shader (301) will read unprocessed vertex data from Vertex Cache (401), execute vertex shader program on them, write the result into the same location in the Vertex Cache (401). Then the geometry shader phase of VG Shader (301) will read processed vertex data from the Vertex Cache (401), execute geometry shader program. After that, the VG Shader (301) will output vertices to the second Primitive Assembly (204).

As show in FIG. 4, an additional attribute with the name “VS-Ready” is introduced for each entry in Vertex Cache (401). When the “VS-Ready” is false, it means the vertex shader program has not been executed on the vertex data in this entry. And the value “true” indicates the vertex data stored in the current entry are result of vertex shader program. After the first Primitive Assembly (202) writes a missed vertex into Vertex Cache (401), its “VS-Ready” is initialized as “false”. The vertex shader phase of VG

Shader (301) will check all “VS-Ready” attributes of vertices in current primitive. If any vertex's “VS-Ready” is false, execute vertex shader program on it and set “VS-Ready” to “true”; if it is “true”, just ignore the vertex shader program. When all vertices of a primitive have “true” values for “VS-Ready”, the primitive can enter the geometry shader phase. The fore-mentioned example can also used here. Assume that two triangles, t0(v0,v1,v2) and t1(v1,v2,v3), will be sent to VG Shader (301) from The first Primitive Assembly (202). All “VS-Ready” values are initialized to “false”. After getting t0(v0,v1,v2), the VG Shader (301) will first execute vertex shader program on v0, v1 and v2 because their “VS-Ready” are all “false”. After that, their “VS-Ready” will be set to “true”, just like the situation showed in FIG. 4. Next time when VG Shader (301) handles t1(v1,v2,v3), it will skip executing vertex shader program on v1 and v2 because their “VS-Ready” are “true”. Any way, the vertex shader program on v3 cannot be skipped.

Practically, to cover the latency of executing ALU instructions, or latency of texture accesses, multiple VG Shader threads may be executed in one VG Shader unit. The Vertex Cache (401) should handle the situation, which multiple VG Shader threads access the same entries in Vertex Cache. This target can be accomplished by adding another control attribute into each vertex entry of Vertex Cache, the “VS-Busy”. This attribute indicates whether there is some thread is executing vertex shader program on current vertex entry. Accompanied with some hardware mutex mechanism, this additional control attribute can support multiple VG Shader threads in one VG Shader unit.

The graphics API sends vertex shader context and geometry shader context to driver separately, it is driver's responsibility to compile and combine the two kinds of shader contexts into one single VG Shader context, which will later be installed on VG Shader unit. Such combination includes combining constant buffers, combining shader programs, etc. When combining shader programs, some special shader instructions are added. The following pseudo code shows a VG Shader program after driver's compilation and combination.

| | |
|---|---|
| (1) | // Vertex Shader phase |
| (2) | Check_flag = false; // initialize Check_flag to false |
| (3) | For each vertex in primitive { |
| (4) | If ( vertex.VS-Ready is true ) |
| (5) | continue; //skip vertex which has been handled by vertex |

shader program.

| | |
|---|---|
| (6) | else if ( vertex.VS-Busy is true ) { |
| (7) | // some other thread is executing vertex shader program on |

current vertex.

| | |
|---|---|
| (8) | Check_flag = true; |
| (9) | continue; //skip vertex being processed by other thread. |
| (10) | } |
| (11) | else { // execute VS program on unprocessed vertex |
| (12) | // Original VS program on current vertex |
| (13) | ... |
| (14) | } |
| (15) | } |
| (16) | // Geometry Shader phase |
| (17) | if (Check_flag == true) |
| (18) | sleep until all vertices in primitive have “true” value for |

VS-Ready

| | |
|---|---|
| (19) | // Original GS program on current primitive |
| (20) | ... |
| (21) | emit |
| (22) | ... |

In this pseudo VG Shader program, line (13) stands for original Vertex Shader program, lines (20-22) stand for original Geometry Shader program. The other instructions, excluding comments, are added to avoid redundant VS processing and support multiple VG Shader threads.

Doing vertex shader on primitive base is an import feature of present invention. That's to say, the primitive information is available even during pre-vertex processing. The unconventional feature can be utilized to do “Two Level VS”. The original vertex shader program is split into two levels. The first level VS produces positions and the necessary attributes. The second level VS produces other attributes which are not calculated by first level VS. After doing first level VS on the given vertices, do clipping/culling to determine whether the vertices will be dropped. For totally dropped vertex, such as an object behind a wall, just ignore its second level VS and GS.

Typically, vertex shader program calculates many attributes for every vertex, such as position, color, texture coordinates, etc. Within these vertex attributes, the position is used for clipping/culling to drop invisible primitives. If the vertex is totally dropped, only its position is useful for clipping/culling. The other attributes, such as color, texture coordinates, etc., are never used. The vertex shader instructions to calculate such useless attributes can be skipped. This can save some vertex calculation and increase geometry performance greatly.

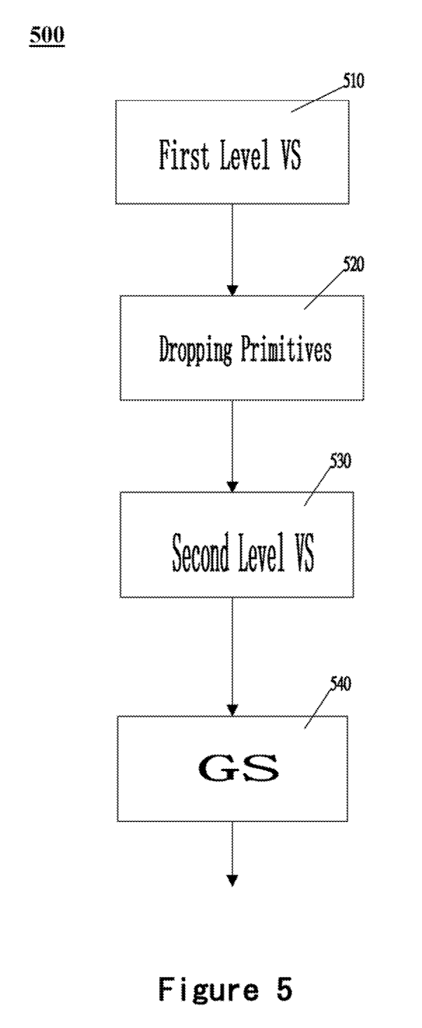

In conventional graphics pipeline, it is hard to do “Two Level VS” because the vertex shader program is executed on vertex base without knowledge of primitive information, which is necessary to drop invisible primitives. But when given the VG Shader architecture of the present invention, “Two Level VS” is easy to implement. The flow chart of “Two Level VS” in VG Shader architecture can be found in FIG. 5. If we implement “Two Level VS” in VG Shader, the VG Shader program can be split into four stages. The first stage executes the first level VS (510). The necessary vertex and attributes are calculated. Next, the second stage drops the invisible primitives (520). Next, the third stage executes the second VS (530). The rest of the vertex and attributes are calculated. Last, GS is executed (540).

For example, there are two triangles (t0, t1) sharing a vertex v0. After the first level VS, t0 is dropped since it is invisible. Another VGS thread processes t1. It skips the first level VS of v0 (the attribute of v0, VS-Ready, is true). But it still needs to handle the second level VS for v0 (the attribute of v0, VS-Ready1 us false). This is because t0 is dropped without processing the second VS and GS.

More control attributes are needed for vertex entries in Vertex Cache (401) to support “Two Level VS”. For example, we need “VS-Ready”/“VS-Busy” for the first level VS, and “VS-Ready1”/“VS-Busy1” for the second level VS. As showed in FIG. 5, if a primitive can be dropped in the Second Stage, the second level VS and geometry shader instructions can all be skipped, which is pretty helpful for performance.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use of implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A graphics processing system, comprising:
a first converting circuit converting a first data format into a second data format;
a processor executing a first shader program and a second shader program, receiving an input in said second data format, and outputting a result in said first data format; and
a second converting circuit converting said first data format into said second data format, wherein said input comes from said first converting circuit and said result is output to said second converting circuit.

2. The graphics processing system according to the claim 1, further comprising a storage device recording a status relevant to said first program for said processor to access.

3. The graphics processing system according to the claim 1, wherein said first data format comprises a vertex format.

4. The graphics processing system according to the claim 1, wherein said second data format comprises a primitive format.

5. The graphics processing system according to the claim 1, wherein said first shader program comprises a vertex shader program.

6. The graphics processing system according to the claim 1, wherein said second shader program comprises a geometry shader program.

7. The graphics processing system according to the claim 1, further comprising a texture unit to provide texture information for said processor.

8. A graphics processing method, comprising:
converting a graphics data from a vertex format into a primitive format;
executing a vertex shader program on said graphics data in said primitive format;
generating a first result in said primitive format;
executing a geometry shader program on said first result in said primitive format;
generating a second result in said vertex format; and
converting said second result from said vertex format into said primitive format.

9. The graphics processing method according to the claim 8, further comprising providing a first texture access from a texture engine when executing said vertex shader program.

10. The graphics processing method according the claim 8, further comprising providing a second texture access from said texture engine when executing said geometry shader program.

11. The graphics processing method according to the claim 8, further comprising splitting said shader program into a first level shader program and a second level shader program when executing said vertex shader program.

12. The graphics processing method according to the claim 8, wherein said graphics data in said primitive format comprises a position attribute and a plurality of property attributes.

13. The graphics processing method according to the claim 12, wherein said property comprises a color, a lightness, or a plurality of texture coordinates.

14. The graphics processing method according to the claim 8, further comprising ignoring said property attributes of said graphics data when executing said vertex shader program.
